(19) United States
(12) Patent Application Publication
(10) Pub. No.: US 2002/0074430 A1
(43) Pub. Date: Jun. 20, 2002

(54) Multiposition hand shower

(75) Inventors: Eckhard Gransow, Frondenberg (DE); Hans Lobermeier, Menden (DE); Bernd Bischoff, Hemer (DE); Hans-Peter Strelow, Freiburg (DE); Sascha Korfer, Hemer (DE); Holger Ellerbrock, Unna (DE); Andreas Kirchhoff, Wickede (DE); Thomas Raadts, Frondenburg (DE); Joachim Stork, Kippenheimg (DE); Hans-Jurgen Linde, Coburg (DE); Uwe Neumann, Bamberg (DE); Andreas Rehklau, Coburg (DE)

Correspondence Address: THE FIRM OF KARL F ROSS, 5676 RIVERDALE AVENUE, PO BOX 900, RIVERDALE (BRONX), NY, 10471-0900, US

(73) Assignee: Friedrich Grohe AG & Co. KG

(21) Appl. No.: 09/991,465

(22) Filed: Nov. 16, 2001

(30) Foreign Application Priority Data
Dec. 20, 2000 (DE) 10063956.9

(51) Int. Cl. B05B 15/08

(52) U.S. Cl. 239/397; 239/390; 239/587.1

(57) ABSTRACT

A hand shower has a handle having an outer part extending along a handle axis and having an outer face and a shower head forming at least one spray opening directed along a spray axis extending nonparallel to the handle axis. a pivot between the handle and shower head allows pivoting of the head on the handle about a pivot axis inclined at 30° to 90° to the handle axis, normally 45°. The pivot axis extends at an angle between 35° and 50° to the spray axis.

### FIELD OF THE INVENTION

The present invention relates to a hand shower. More particularly this invention concerns such a hand shower whose spray head can be set at different angles with respect to its handle.

### BACKGROUND OF THE INVENTION

A standard hand shower has a head from which a spray is emitted in a direction normally generally perpendicular to an axis of the handle or body of the shower. This body is held in the hand and the user directs the spray at the body parts to be washed or rinsed. Such a system is convenient for bathing, but is somewhat more difficult to use for shampooing the hair, washing down the shower walls, or spraying some parts of the user's body portion. If, for example, the user cares to direct a spray at the lower back to ease back pain the standard hand shower is extremely difficult and uncomfortable to use.

Thus it is known to provide a wall mount so that the shower can be fixed on the wall at one or more levels. Such an arrangement makes shampooing easy, but still does not allow, for instance, a horizontal spray to be emitted for spraying a back or leg for spray massage. Furthermore directing the spray upward to wash down the shower walls is particularly difficult.

German patent document 2,246,520 of Arbon describes a shower having a head whose spray is directed at about 45° to an axis of the body, and the head is pivotal about the body axis so that the spray can be pointed in various directions relative to the handle body. While this arrangement is somewhat more convenient than the fixed-angle sprayers, it still does not allow, for instance, a spray to be emitted parallel or perpendicular to the body axis, and otherwise cannot assume certain positions.

### OBJECTS OF THE INVENTION

It is therefore an object of the present invention to provide an improved hand shower.

Another object is the provision of such an improved hand shower which overcomes the above-given disadvantages, that is which can assume virtually any desired position, even directing a spray horizontally or straight up if needed.

A further object is to provide such a sprayer that can be used with a conventional wall-mount rod to provide a wide range of different spray positions.

### SUMMARY OF THE INVENTION

A hand shower has a handle having an outer part extending along a handle axis and having an outer face and a shower head forming at least one spray opening directed along a spray axis extending nonparallel to the handle axis. According to the invention a pivot between the handle and shower head allows pivoting of the head on the handle about a pivot axis inclined at 30° to 90° to the handle axis, normally 45°.

With the system of this invention the spray emitted by the head can be directed at virtually any angle relative to the handle. Thus in a wall-mount system the hand shower can be set to spray downward, horizontally, or even upward. When used by hand the ability to point the spray in virtually any direction relative to the handle is particularly convenient, for instance, when the device is used to wash the shower walls it can be pointed upward easily.

The pivot axis in accordance with the invention extends at an angle between 35° and 50° to the spray axis. This orientation further increases the versatility of the hand shower according to the invention. The handle according to the invention is arcuate and has an inner part generally perpendicular to the pivot axis.

The head is substantially part spherical and has an outer circular rim and an inner circular rim and comprises a generally flat spray plate secured to the outer rim. The inner rim rides on the outer end of the handle. The rims lie in respective planes forming an acute angle with each other. The plane of the inner rim extends perpendicular to the pivot axis.

The head in accordance with the invention forms a pair of separate compartments and is formed with an array of spray holes opening to the exterior from one of the compartments and at least one different spray hole opening to the exterior from the other of the compartments. The array of spray holes forms a multijet spray and the one different spray hole forms a curtain spray. In addition the head is formed offset from the pivot axis with a throughgoing feed hole opening into the one compartment and, at a different spacing from the axis, with another throughgoing feed hole opening into the other compartment. The handle is formed centered on the pivot axis with a pair of annular distribution passages respectively communicating with the feed holes. A valve in the handle feeds pressurized water alternately to the passages. This valve is provided with a spring biasing it into a position feeding the pressurized water to the one compartment. It is movable into another position feeding the pressurized water to the other compartment and is constructed such that, when in the other position and when the valve is pressurized, the valve stays in the other position. Alternately a flow-control valve could be provided in the handle.

The handle according to the invention includes a core body on which the head is pivoted and which has an inner end adapted for connected to a supply hose, and a shell surrounding the core body and having formations snap fitted thereto.

### BRIEF DESCRIPTION OF THE DRAWING

The above and other objects, features, and advantages will become more readily apparent from the following description, reference being made to the accompanying drawing in which:

FIGS. 1 and 2 are side views of a shower according to the invention in to different positions;

FIG. 3 is a view like FIG. 1 of another shower in accordance with the invention;

FIG. 4 is a larger-scale section through the outer portion of shower of FIG. 3 set for curtain spray;

FIG. 5 is a view like FIG. 4 but set for normal spray;

FIG. 6 is a view like FIG. 5 but with the shower head twisted through 180° as in FIG. 2; and

FIG. 7 is a small-scale side view illustrating use of the shower of FIG. 3 in three different positions.

### SPECIFIC DESCRIPTION

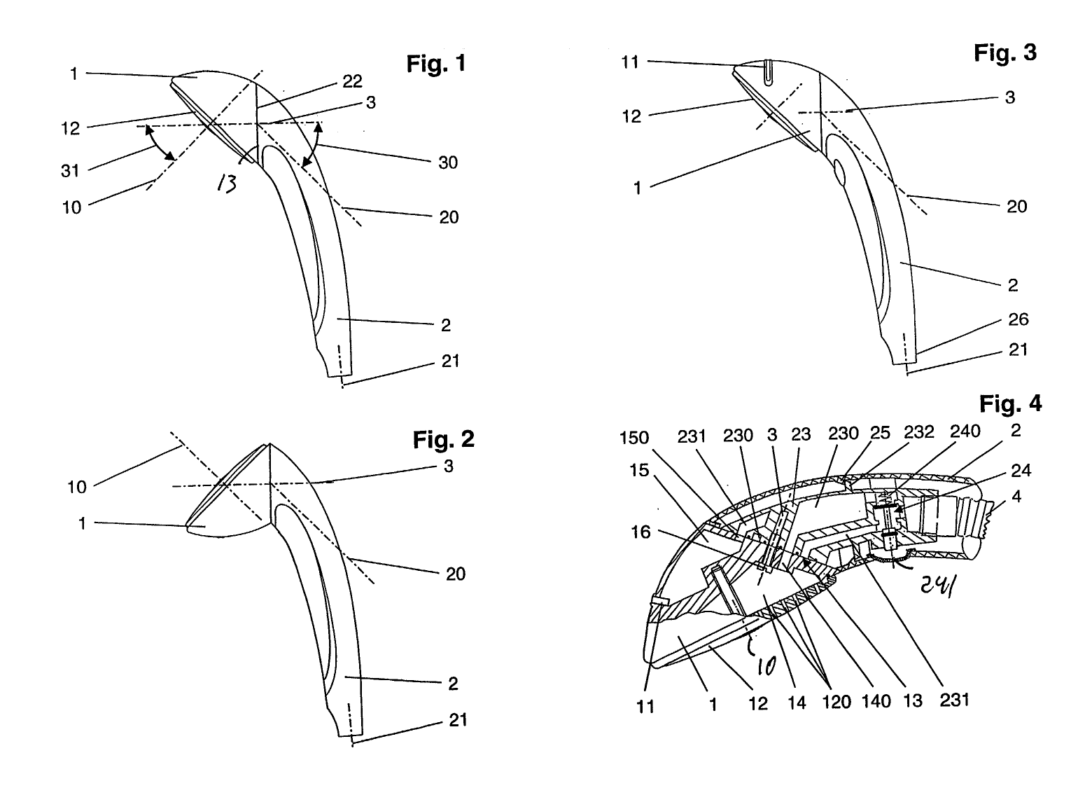

As seen in FIGS. 1 and 2 a hand shower according to the invention has a head 1 and a handle 2, the latter being arcuate and having an outer part extending along an axis 20 and an inner part extending along an axis 21 forming a small acute angle with the axis 20. The head 1 has a flat inner rim or face 22 that can pivot on a flat outer face or rim 13 of the handle 2 about an axis 3 forming an angle 30 of about 45° to the axis 20, the two faces 13 and 22 extending perpendicular to the axis 3. The head 1 further has generally flat spray plate 12 formed with openings (120 in FIG. 4) that are directed generally parallel to an axis 10 forming an angle 31 of about 45° to the axis 3. Thus as shown in FIG. 1 in a normal position, which is the position most fixed-angle hand showers use, the spray parallel to the axis 10 is directed roughly perpendicular to the axis 20 of the outer end of the handle 2. When, however, the head 1 is pivoted through 180° about the axis 3 as shown in FIG. 2, the spray axis 10 is directed parallel to the handle axis 20.

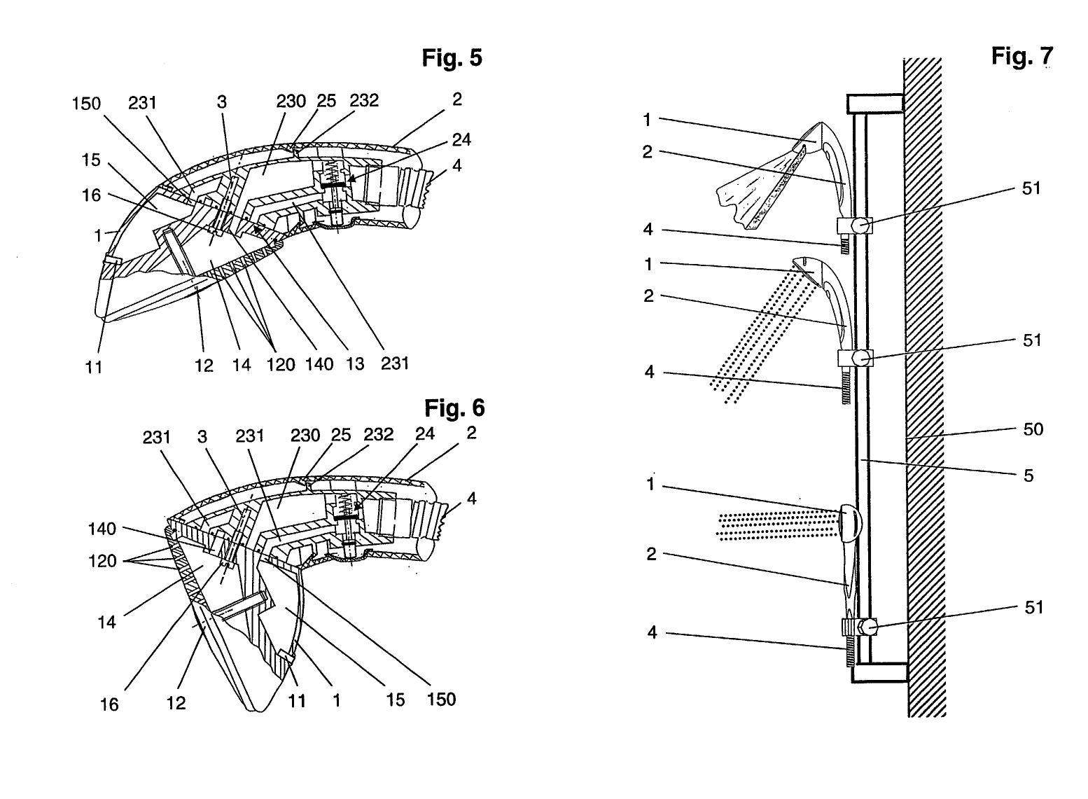

FIGS. 3 through 6 show a variation on this system, where identical reference numerals are used for functionally identical structure. Here the handle 2 has a body 23 into which is fitted one end of a supply hose 4 and on which two parts forming the handle 2 are snapped by engagement of barbs 25 on the handle 2 with an annular and outwardly directed rib 232 on the body 23.

The head 1 is secured via a bolt 1 at the axis 3 to the body 23 and has a pair of compartments 14 and 15. The compartment 14 communicates via a hole 140 with an annular distributing passage 230 in the body 23 and via the spray holes 120 with the exterior, these holes 120 being directed parallel to the axis 10. The compartment 15 communicates via a hole 150 with an annular distributing passage 231 on the body 23 and via a slot 11 with the exterior, this slot 24 opening roughly perpendicular to the axis 3 and at about 45° to the axis 10. The distributor passages 230 and 231 are annular, of different diameters, and centered on the axis 3 so that in all angular positions of the head 1 they communicate with the respective holes 140 and 150.

A valve 24 in the body 23 can direct water from the supply conduit 4 to either the passage 230 or 231. A spring 240 normally urges the valve 24 into a position diverting flow to the distributing passage 230 and thence through the hole 140 into the compartment 14 to form a multijet spray emitting from the holes 120 parallel to the axis 10. This is the normal spray position. When a membrane 241 is pressed, the valve 24 diverts flow to the distributing passage 231 and thence through the hole 150 into the compartment 15 to form a single curtain spray emitting from the slot 11 perpendicular to the axis 3. In this latter position water pressure will hold the spring compressed so that, once the valve 24 is actuated, it will stay in the curtain-spray position until pressure is relieved and the spring 240 can return it to the normal multijet-spray position.

FIG. 7 shows how a lower end 26 of the handle 2 can be fitted to a holder 51 carried on a vertical rod 5 mounted on a wall 50. In the lowermost position the spray is emitted from the holes 120 virtually horizontally. In the middle position the spray is directed downward at an angle of about 45°. In the upper position valve 24 is actuated and the head 1 is turned around through 180° relative to the middle position to direct a curtain spray downward at about 45°. Of course all intermediate positions are also possible.

We claim:

1. A hand shower comprising:
a handle having an outer part extending along a handle axis and having an outer face;
a shower head forming at least one spray opening directed along a spray axis extending nonparallel to the handle axis; and
pivot means between the handle and shower head for pivoting the head on the handle about a pivot axis inclined at 30° to 90° to the handle axis.

2. The hand shower defined in claim 1 wherein the pivot axis extends at 45° to the handle axis.

3. The hand shower defined in claim 1 wherein the pivot axis extends at an angle between 35° and 50° to the spray axis.

4. The hand shower defined in claim 1 wherein the handle is arcuate and has an inner part generally perpendicular to the pivot axis.

5. The hand shower defined in claim 1 wherein the head is substantially part spherical and has an outer circular rim and an inner circular rim and comprises a generally flat spray plate secured to the outer rim, the inner rim riding on the outer end of the handle.

6. The hand shower defined in claim 5 wherein the rims lie in respective planes forming an acute angle with each other, the plane of the inner rim extending perpendicular to the pivot axis.

7. The hand shower defined in claim 1 wherein the head forms a pair of separate compartments and is formed with an array of spray holes opening to the exterior from one of the compartments and at least one different spray hole opening to the exterior from the other of the compartments.

8. The hand shower defined in claim 7 wherein the array of spray holes form a multijet spray and the one different spray hole forms a curtain spray.

9. The hand shower defined in claim 7 wherein the head is formed offset from the pivot axis with a throughgoing feed hole opening into the one compartment and, at a different spacing from the axis, with another throughgoing feed hole opening into the other compartment, the handle being formed centered on the pivot axis with a pair of annular distribution passages respectively communicating with the feed holes.

10. The hand shower defined in claim 9, further comprising valve means in the handle being for feeding pressurized water alternately to the passages.

11. The hand shower defined in claim 9 wherein the valve means is provided with a spring biasing it into a position feeding the pressurized water to the one compartment.

12. The hand shower defined in claim 11 wherein the valve is movable into another position feeding the pressurized water to the other compartment and is constructed such that, when in the other position and when the valve is pressurized, the valve stays in the other position.

13. The hand shower defined in claim 1 wherein the handle includes
a core body on which the head is pivoted and which has an inner end adapted for connected to a supply hose, and
a shell surrounding the core body and having formations snap fitted thereto.
